(19) United States
(12) Patent Application Publication
(10) Pub. No.: US 2013/0312921 A1
(43) Pub. Date: Nov. 28, 2013

(54) CURTAIN CABLE POSITIOING DEVICE

(71) Applicants: SHENG YING HSU, CHANGHUA COUNTY (TW); WU-CHUNG NIEN, CHANGHUA COUNTY (TW)

(72) Inventors: SHENG YING HSU, CHANGHUA COUNTY (TW); WU-CHUNG NIEN, CHANGHUA COUNTY (TW)

(73) Assignee: CHING FENG HOME FASHIONS CO., LTD., CHANGHUA COUNTY (TW)

(21) Appl. No.: 13/481,678

(22) Filed: May 25, 2012

(51) Int. Cl. A47H 1/18; F16G 11/00

(52) U.S. Cl. 160/368.1; 24/129 R

(57) ABSTRACT

A curtain cable positioning device is engaged with the hole in the head box and the underside of the curtain cable positioning device is in contact with the inside of the head box. The curtain cable positioning device includes a body with two recesses defined in two opposite sides thereof and two arms extend from the underside of the body. The two arms are engaged with the hole of the head box. A slot is defined between the two arms and two notches are respectively defined in two ends of the body. The cable passes through the notch and the slot, and is connected with the curtain. The cable is not loosened or hooked to other parts in the head box.

### FIELD OF THE INVENTION

The present invention relates to a curtain cable positioning device, and more particularly, to a curtain cable positioning device for maintaining proper tension of the curtain cable.

### BACKGROUND OF THE INVENTION

As shown in FIGS. 5 to 7, the conventional window curtain has a head box 20 which has two holes 22 and two rings 40 are engaged with the holes 22 respectively. The head box 20 has two mandrels 21 to which two respective cables 210 are wrapped and the rings 40 each have a passage 41 through which the cable 210 extends. The cables 210 are easily loosened due to unbalanced force applied thereto when the user holds the bottom bar of the curtain 30 and moves the bottom bar up and down. When the user operates the bottom bar of the curtain 30, the curtain 30 may tilt and the two cables 210 on two sides of the curtain 30 are not moved simultaneously so that the two mandrels 20 cannot scroll the cables 210 simultaneously. The cable 210 located on the side of the curtain 30 that raises first cannot be wrapped to the mandrel 21 properly and is then loosened. The loosened cable 210 is accumulated in the head box 20 and may be hooked with other parts. Once the cables 210 are loosened or hooked with other parts, the function for controlling the curtain 30 fails and the head box 20 has to be detached from the curtain 30 and checked.

The present invention intends to provide a curtain cable positioning device which improves the shortcomings of the conventional curtain cable.

### SUMMARY OF THE INVENTION

The present invention relates to a curtain cable positioning device and comprises a body having two recesses defined in two opposite sides thereof and each of the two recesses has an arm extending from the inner side thereof. The two respective arms extend beyond the underside of the body. A slot is defined between the two arms. Two notches are respectively defined in the bottom board of two ends of the body and the two notches communicate with the slot. The body is engaged with the hole in the underside of the head box of the curtain. The two ends of the body are matched with the top surface of the bottom board of the head box and the two arms extend through the hole and are in contact with the inner periphery of the hole. The cable extends through the notch and the slot, and extends out from the head box and is connected to the curtain.

When the two sides of the curtain are applied by uneven forces and the curtain tilts, the cable located on one side of the curtain that is lifted first can be restricted by the bottom surface of the notch so that it is not loosened and can be wrapped to the mandrel. The shortcoming of the conventional curtain is improved.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the curtain and the head box with the curtain cable positioning device of the present invention;

FIG. 2 is a perspective view to show the curtain cable positioning device of the present invention;

FIG. 3 is a cross sectional view to show the cable passing through the curtain cable positioning device of the present invention;

FIG. 4 shows that the curtain cable positioning device of the present invention is clamped by pliers;

FIG. 5 shows the curtain and the conventional head box with the ring engaged with the hole in the head box;

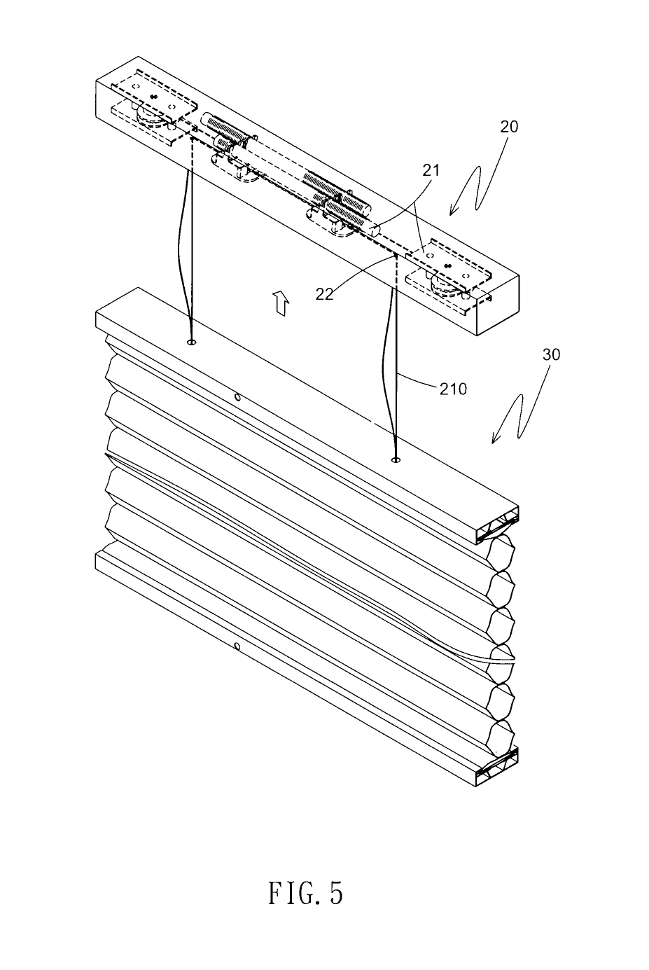

FIG. 6 is a cross sectional view to show the cable passing through the hole in the conventional head box, and

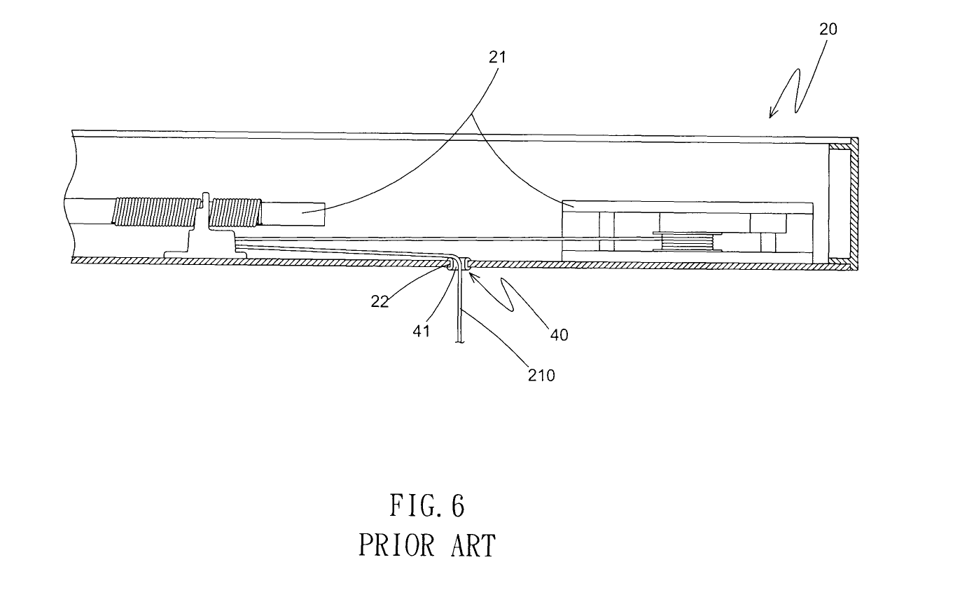

FIG. 7 shows that the cable is loosened in the conventional head box.

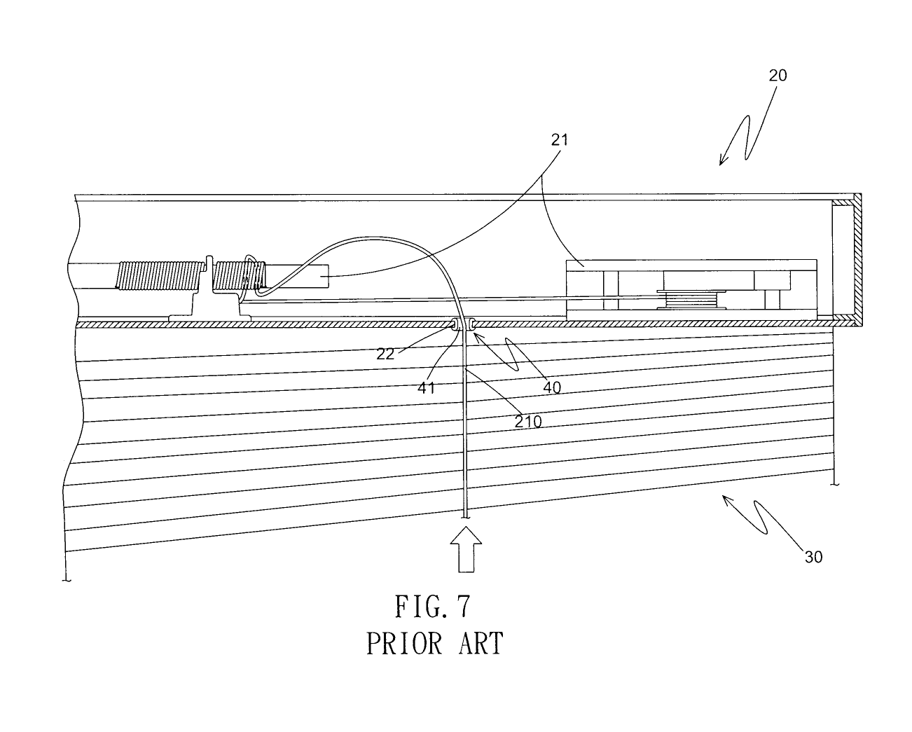

### DETAILED DESCRIPTION OF THE PREFERRED EMBODIMENT

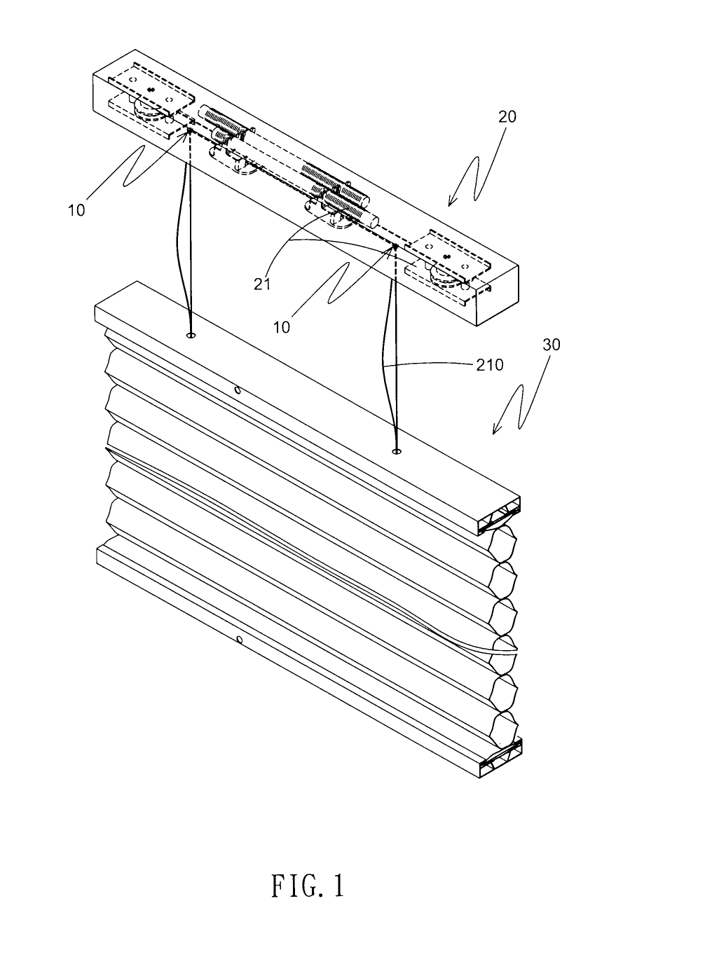

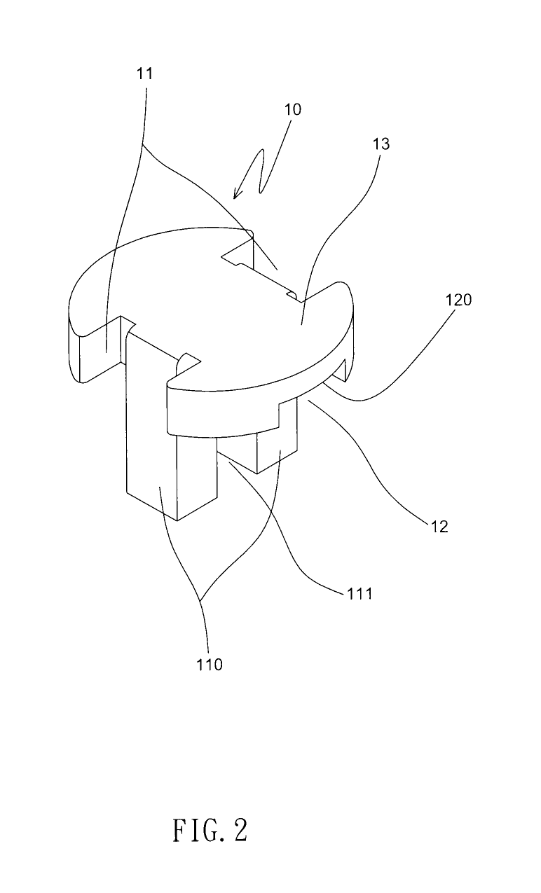

Referring to FIGS. 1 and 2, the curtain cable positioning device of the present invention comprises a body 10 having two recesses 11 defined in two opposite sides thereof and each of the two recesses 11 has an arm 110 extending from the inner side thereof. The two arms 110 are perpendicular to the two recesses 11. The two respective arms 110 extend beyond the underside of the body 10 and a slot 111 is defined between the two arms 110. Two notches 12 are respectively defined in the underside of two ends 13 of the body 10 and each of the two notches 12 has a bottom surface 120. The two notches communicate with the slot 111.

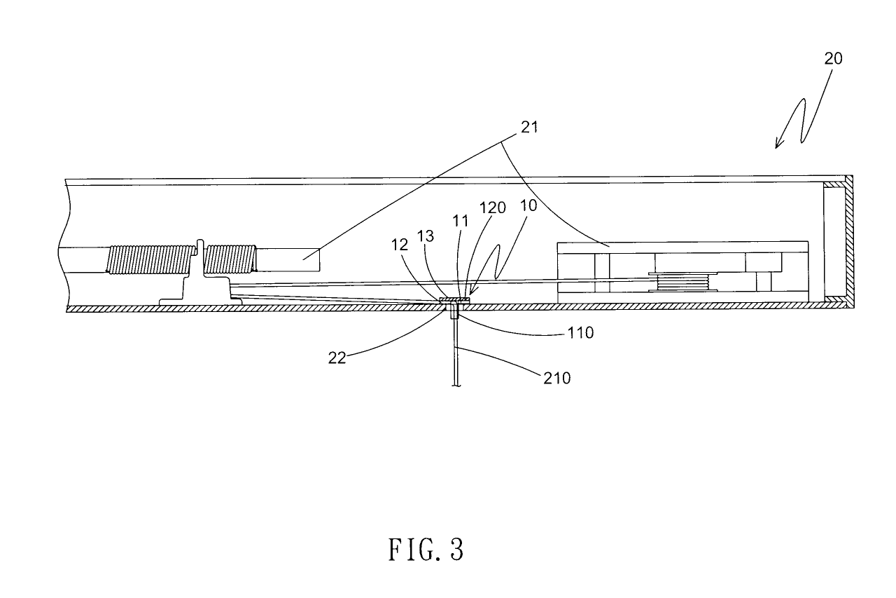

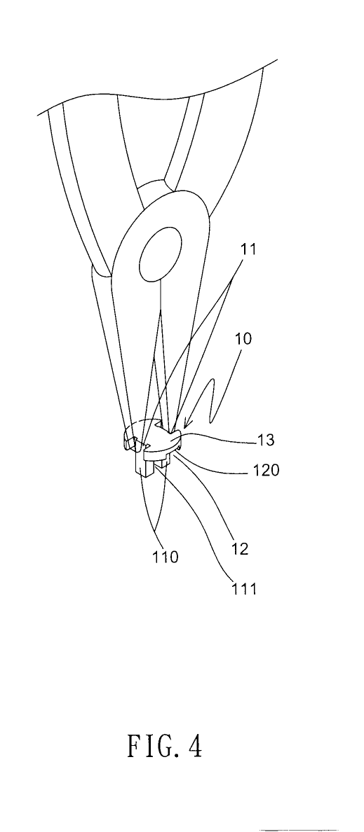

Referring to FIGS. 3 and 4, the curtain cable positioning device is cooperated with a head box 20 of the curtain, wherein the head box 20 has two mandrels 21 located therein and each mandrel 21 has a cable 210 wrapped therearound. Two holes 22 are defined through the bottom board of the head box 20 and the body 10 is engaged with each of the holes 22. Each of the two ends 13 of the body 10 is larger than the diameter of the hole 22 of the head box 20 so that the two ends 13 of the body 10 are matched with the top surface of the bottom board of the head box 20. The two arms 110 extend through the hole 22 and are in contact with an inner periphery of the hole 22. The distance between two respective outer sides of the two arms 110 is larger than the diameter of the hole 22 of the head box 20. The arms 110 are made by plastic material and have proper flexibility so that the two arms 110 are able to be secured in the hole 22. The cable 210 extends through the notch 12 and the slot 111, and extends out from the head box 20 and is connected to the curtain 30. It is noted that the cable 210 is restricted by the bottom surface 120 of the notch 12 corresponding thereto so that the cable 210 is maintained with proper tension.

When the two sides of the curtain 30 are applied by two uneven forces and the curtain 30 tilts, the cable 210 located on one side of the curtain 30 that is lifted first is restricted by the bottom surface 120 of the notch 12 so that it is not loosened and can be wrapped to the mandrel 21 properly. In other words, the cables 210 are not loosened and accumulated in the head box 20.

The installation of the body 10 is easy by using a pair of pliers to clamp the body 10, the two jaws of the pliers are engaged with the two recesses 11 as shown in FIG. 4, the body 10 is easily inserted into the hole 22 of the head box 20.

While we have shown and described the embodiment in accordance with the present invention, it should be clear to those skilled in the art that further embodiments may be made without departing from the scope of the present invention.

What is claimed is:

1. A curtain cable positioning device comprising:
a body having two recesses defined in two opposite sides thereof and each of the two recesses having an arm extending from an inner side thereof, the two respective arms extending beyond an underside of the body, a slot defined between the two arms, two notches respectively defined in the underside of two ends of the body, the two notches communicating with the slot.

2. The device as claimed in claim 1, wherein the two arms are perpendicular to the two recesses.

3. The device as claimed in claim 1, wherein each of the two notches has a bottom surface.

4. A curtain cable positioning device comprising:
a body having two recesses defined in two opposite sides thereof and each of the two recesses having an arm extending from an inner side thereof, the two respective arms extending beyond an underside of the body, a slot defined between the two arms, two notches respectively defined in the underside of two ends of the body, the two notches communicating with the slot, and
a head box having multiple mandrels located therein and each mandrel having a cable wrapped therearound, multiple holes defined through a bottom board of the head box and the body engaged with each of the holes and the two ends of the body being matched with a top surface of the bottom board of the head box, the two arms extending through the hole and being in contact with an inner periphery of the hole, the cable extending through the notch and the slot and extending out from the head box.

5. The device as claimed in claim 4, wherein the two arms are perpendicular to the two recesses.

6. The device as claimed in claim 4, wherein each of the two notches has a bottom surface.

7. The device as claimed in claim 4, wherein each of the two ends of the body is larger than a diameter of the hole of the head box.

8. The device as claimed in claim 4, wherein a distance between two respective outer sides of the two arms is larger than a diameter of the hole of the head box.
